(19) United States
(12) Patent Application Publication
(10) Pub. No.: US 2008/0006749 A1
(43) Pub. Date: Jan. 10, 2008

(54) Multi-purpose utility-stand suitable for laptop-PC's

(76) Inventor: George A. Ferritto, Dublin, OH (US)

Correspondence Address: GEOREGE A. FERRITTO, 7588-A SAWMILL COMMONS ROAD, DUBLIN, OH, 43016, US

(21) Appl. No.: 11/482,241

(22) Filed: Jul. 5, 2006

(51) Int. Cl. F16M 11/38

(52) U.S. Cl. 248/188.6

(57) ABSTRACT

A multi-purpose utility-stand at once foldable into a low-profile hand-portable unit stowing as easily as a book upon a shelf, the ProviewStand™ is comprised of two similar frame-sections arranged one above the other, and cooperating via a transverse frontal hinge-axis; whereto a separate transverse adjuster-rod is simply selectively repositioned fore/aft into plural detents provided in the left and right longitudinal side-rails of the stationary horizontal lower/resting-frame; —whereby the user is thereby able to readily set the upper/resting-frame at the attitude they prefer for the particular task at hand. For example, if this utility-stand were to be used in the kitchen to hold a recipe-book, or by a musician to hold their sheet-music, —then a relatively steep upward-angularity of about 70-degrees would usually be desired; but if the apparatus were to be used upon one's desktop, or upon their lap while traveling, —then a relatively low angularity of about 20-40 degrees may be more ergonomicly comfortable for operating a conventional laptop-PC. Accordingly, my utility-stand is adaptable to a wide variety of convenient usages, and generic-variant embodiments of different indexing detents and associated adjustment-rod configurations are set forth; plus, it includes provision of a flat'stow-mode, whereby the adjuster-rod is held captive from loss within the stow-recesses of the hinged-closed framework; —whereby it may be conveniently stored amongst books on an ordinary bookshelf ready at hand for subsequent use.

### I.) BACKGROUND OF THE INVENTION

1. Field of Invention

This invention relates to universal usage multi-purpose desk-top utility-stands; and more specifically it relates to those types of stands which serve to improve user human-engineering ergonomics, such as for Laptop-pc's; and it is to be noted that this invention-disclosure was initiated in part via Provisional/Patent-application No. 60/648,594 filed—31, Jan. 2005, —which became unintentionally abandoned just prior to date of this refiling.

2. Relevant Prior-Art

Background research discovery provides some prior patent-art regarded as germane to this disclosure, chronologically for example U.S. Pat. No. 5,915,661(filed: August 1997) contemplates a folding desk-top stand for a laptop-PC, and employs a bent metal-wire construction, whereto is included a horizontal base-frame(44) member to which is hinged an adjestable pitch-angle U-shaped resting-frame (50) and a laterally-opposed pair of slide-abutment arms (58/60); —plus, the entire framework-assembly folds flat for compact portability. The configuration is not bad, however the structural construction does not lend itself well to other materials, and therefore the skeletal-appearance does not have so substantial aesthetic appeal to many potential users.

In US. Pat. No. D495,337(filed: February 2003) is shown a utility-stand for laptop-PC's, and also is of a hand-portable foldable bent metal-wire type of construction, but employing a 3-point type of desk-top support; —which is economical to produce yet provides limited visual appeal, and is slow to readjust to different positions.

In pending US. Pat. No. 2004/007649(filed: April 2003) is shown a wood or plastic desk-top utility-stand for laptop-PC's, and employs a horizontal U-shaped base member t(127) to which is frontally hinged a pitch-angle adjustable resting-platen(113); and includes a single central inverted-U shaped support-strut(104) which is hinged from the upper resting-platen down into plural indexing-notches, or may be swung fore/aft to facilitate flat-folding of the aggregate framework-structure.

Additionally of note, there is a laptop-PC utility-stand on the market by name of TravelRite®, which comprises a lower-platform to which is frontally hinged an upper-platform that is finitely (not positive increments) pitch-adjustable via a roller-bar extending transveresly between the two platforms.

Therefore, in full consideration of the preceding patent review, there is determined a need for an improved form of device to which these patents have been largely addressed. The instant inventor hereof believes their newly improved multi-purpose utility-stand, commercially referred to as the Proviewstand™, recently being introduced and produced under auspices of the JOID-Mfg./Mkt.Co.-IIc, —exhibits certain advantages as shall be revealed in the subsequent portion of this instant disclosure.

### II.) SUMMARY OF THE INVENTION

A.) In view of the foregoing discussion about the earlier invention art, it is therefore important to make it pellucid to others interested in the art that the object of this invention is to provide a multi-purpose hand-portable utility-stand for universal applications, albeit particularly suited to usage serving to support articles such as a conventionsal laptop-PC, or a reference-book (such as holding a cookbook upon my utility-stand while set atop one's kitched-countertop), displaying of sheet-music, or as an artist's-easel, or for retail-store usage to display signage/graphics, —or even to exhibit a new laptop-PC for sale. My ProviewStand™ is presently quality constructed of hardwood (no tooling requirement), but is also being contemplated for volume-production in injection-molded opaque or transparent plastic, and even in metal such as extruded-aluminum.

B.) Another object of this invention disclosure according to preceeding item-A is to set forth a Universal utility-stand comprising a rigid framework-assembly with a frontal transverse hinge-axis serving the co-hinging function of joining a lower/support-frame to a cooperative upper/resting-frame portion. In a first embodiment, the lower/support-frame employs a plurality of spaced apart detents for selective insertion of a separate transverse adjuster-rod member which impinges upwardly against the underside of the upper/resting-frame portion; —thereby blocking the upper/resting-frame from swinging down upon the lower/support-frame portion.

Accordingly, the closer the user repositions the adjuster-rod to the frontal hinge-axis, the higher the upper/resting-frame becomes elevated; —generally placing the upper/resting-frame at a pitch-attitude of 15-40 degrees from the horizontal reference plane of a desktop surface such for example when being used in conjunction with an existing laptop-PC, to as high as 50-70 degrees from the horizontal when being used upon a countertop conjunction with a reference-book or display of graphics for example. Significant human-engineering ergonomic advantages are to be realized when using my utility-stand to support a conventional laptop-PC at a higher relative elevation, owing that as the laptop-PC's keyboard pitch-angle is increased, it is easier to see the indicia exhibited upon the different typing-keys; plus, the reference lower-edge of the laptop-PC's lid/display-screen also becomes raised some 4″-6″ whereby the seated-user is no longer caused to be poised in a head tilted-forward attitude, —known by physical-therapists to impose neck-musculature strain causing substantial fatigue even leading to painful-trauma.

C.) Another object of this invention disclosure according to preceeding items-A&B is to set forth a universal utility-stand framework-assembly in which its lower/support-stand portion employs a plurality of incrementally spaced apart detents either upon a single medially disposed longitudinal rail member, or more preferably upon a laterally opposed pair of longitudinal side-rails; whereto is included a separately deployable transverse adjuster-rod member for selective indexing into the generally semi-circular said detents. Accordingly, the purchaser receives my utility-stand in a slim planar carton, and upon its removal therefrom in a collapsed condition, it is readily seen that a frontal transverse hinge-axis enables the upper/resting-frame to be folded flatly upon the lower/support-frame; wherein special stow-mode receiver-seats serve to captively retain the adjuster-rod intact with the folded framework-assembly so that this essential adjuster-rod not be misplaced.

A set of opposed hook-&-loop Velcro® type fasteners secure the upper/resting-frame to the lower/support-frame, and are readily avulsed by simply pulling upward upon the upper/resting-frame while the lower/support-stand portion is held stationary upon an existing desk-top surface. The adjuster-rod is then lifted from its stowed position and redeployed into selected detent position which affords the user their desired pitch-attitude of usage; —that is, the user quickly finds that repositioning the adjester-rod closer to the frontal hinge-axis thus raises the upper/resting-frame to pitch-angles of from about 10-degrees from the horizontal to about 70-degrees from the horizontal desk-top surface of reference.

Hence, the clasp-closure facilitates a convenient stow-modality, whereby my utility-stand may be stored upright upon its side, amongst books on most any shelf for ready availability; —while retrieving the stored utility-stand is readily at hand whenever there is need for it. However, many users find that they want to obtain two of my utility-stands, one as permanent augmentation to elevating the height of their existing laptop-PC, and an extra one for use in the home or office as a support-stand for a reference-book or as an artists desk-top painting-easel, enabling them to sit relaxed while painting. In any case, my utility-stand includes a lower: slide-abutment which serves to maintain any article placed atop the upper/resting-frame from slipping off.

### III.) DESCRIPTION OF THE PREFERRED EMBODIMENT DRAWINGS

The foregoing and still other objects of this invention will become fully apparent, along with various advantages and features of novelty residing in the present embodiments, from study of the following description of the variant generic species embodiments and study of the ensuing description of these embodiments. Wherein indicia of reference are shown to match related matter stated in the text, as well as the Claims section annexed hereto; and accordingly, a better understanding of the invention and the variant. uses is intended, by reference to the drawings, which are considered as primarily exemplary and not to be therefore construed as restrictive in nature; wherein:

FIG. 1, is a two-phase diagrammatic side-elevation view exemplifying the ‘before’-condition of a PC-operator at the left, while similarly demonstrating the ‘after’-condition at the right, as to reveal by way of direct comparison the human-engineered ergonomic advantage of my utility-stand in supporting a conventional laptop-PC;

FIG. 2, is a frontal oblique diagrammatic pictorial view exemplifying the present production configuration of my basic utility-stand employing a type-A adjuster-rod cooperatively with a plurality of arched U-shaped scallop like detents incrementally spaced apart symmetrically into a full-perimeter lower/support-frame here resting upon an existing horizontal desk-top surface, and whereto is also shown operationally supported, a conventional laptop-PC indicated via phantom-outline;

FIG. 3, is a frontal oblique diagrammatic pictorial view of my generic-variant utility-stand embodiment, revealing a rudimentary central longitudinal linear unirail lower/support-frame configuration, again employing the preceeding FIG. 2 notion of a plurality of arched U-shaped scallop like detents according to FIG. 2 is preserved, and whereto is shown supported, an exemplified Cookbook indicated via phantom-outline;

FIG. 4A, is a semi-diagrammatic side/elevation-view of FIG. 2 iteration particularly, demonstrating juxtapositioning of the type-A adjuster-rod, including optional usage of an auxiliary-rod as to further elevate the variably-adjustable upper/support-frame portion common to both FIG. 2 and FIG. 3 embodiments;

FIG. 4B, is a pictorial view, showing how the optional auxilary-rod of FIG. 4A is coupled to the adjuster-rod to facilitate alternate pitch-angle adjustability;

FIG. 5, is a semi-diagrammatic side/elevation-view, showing an alternate arrangement employing a single alternate type-B adjuster-rod demonstrated being lodged into similarly arched U-shaped scallop like detents made in spaced apart increments formed to varying depths, thereby facilitating substantially the same adjustability as the above basic version while eliminating need for the optional auxiliary-rod of FIGS. 2 through 4B;

FIG. 6A, is a semi-diagrammatic side/elevation-view, showing a further generic-variant embodiment, wherein both the base-section side-rails and upper holder-section side-rails employ opposed incrementally indexing detents in combination with a type-C adjuster-rod having regular detent engaging cog-wheels, and including an inset-enlargement detailing the frontal-most abutment-flap;

FIG. 6B, is a plan-view projecting downward thereto, showing the type-C adjuster-rod stationed at the right-front corner region of the base-section only (the upper holder-section omitted for sake of visual clarity);

FIG. 6C, is another plan-view taken at left-rear corner thereto, showing the same type-C adjuster-rod lodged into it stow-modality, and revealing how the cogwheels are preferably made to retract transversely inward to allow closing of the upper holder-section.

FIG. 7, is a pictorial view showing how my flatly folded utility-stand can thus be conveniently stored at the ready upon an ordinary bookshelf.

### IV.) ITEMIZED NOMENCLATURE REFERENCES

10′/10″—human: head, neck
11′/11″—reference line-of-vision: before/after
12′/12″—center-of-gravity (head's CG): before after
13—typical existing horizontal platform of reference
14, 14′, 14″—conventional overall laptop-PC, display-screen lower region, keyboard
15—overall framework
16, 16′, 16″—transverse hinge-axis, pivot-hinge, flexural-hinge
17, 17′/17″, 17R/17L, 17U—base-section, front-rail, rear-rail, side-rail: Rt./Lt., upper-side
18, 18′/18″, 18R/18L, 18U—holder-section, fore-rail, aft-rail, spar-rail: Rt./Lt., under-side
19—mono-rail (base-section)
20′/20″—reinforcement-beam: base-section/holder-section
21, 21′, 21″,21G,21R,21S—adj.-rod, axis, flat-sector, gudgeon, stow-recess, inward-stop
22,22′,22″,22C,22S—cog-wheel, cog-rack: lower/upper, hubcap, return-spring
23′,23″,23P,23H—auxiliary-rod, axis, spacer-pin, receiver-hole
24,24′—aux.-rod stow-recess, typical pin stow-hole
25′/25″—adjustment-detent: small/large
26′/26″—closure: avulsable hook portion, avusable loop portion
27—foot-pads
28—existing cookbook or sheet-music
29,29′—pitch-attitude re-adjustment ref.-arrow, gravity sliding action ref.-arrow
30,30′,30″—abutment-pin, pin-holes, stow-holes
31′/31″,31L′/31L″,31A,31P,31T—abutment-flap: down/up, leg: released/impinged, action/ref.-arrow, pivot-axis, page/stay-tabs
32,32′,32″—book-shelf, books, wall

### V.) DETAILED DESCRIPTION OF THE PREFERRED EMBODIMENTS

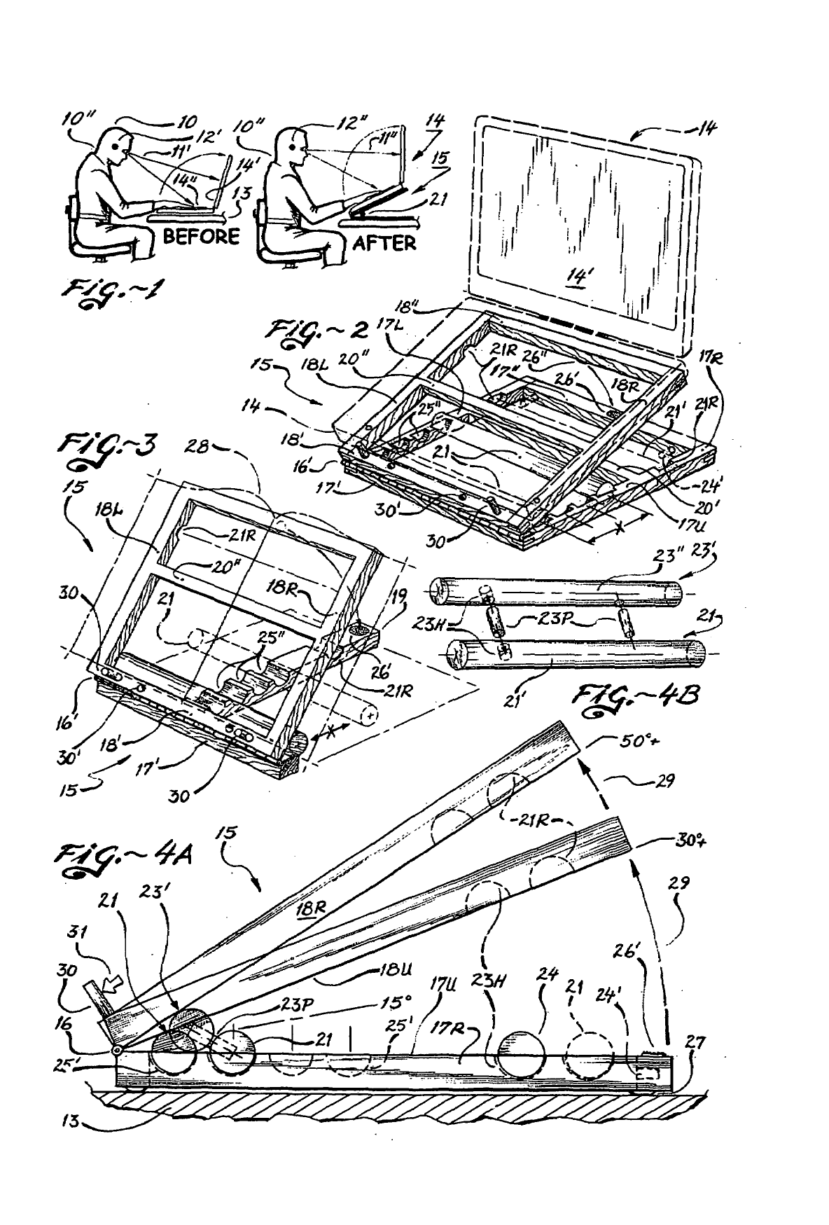

Initial reference is given by way of two-phase FIG. 1 wherein the ‘before’-example at the left is shown a typical user posture caused by a conventional 14 laptop-PC's display-screen 14′ being positioned excessively low in elevation, thus typically causing a user's head 10′ to be subconsciously tilted forward, hence positioning the head's CG(center-of-gravity) forward 12′ as to thereby impose potentially debilitating stress upon the supporting neck-musculature 10″ when tilted forward along the indicated adverse/eye-line of vision 11′. In significant contrast however, the ‘after’ example at the right side of FIG. 1 demonstrates that by elevating the laptop-PC's display-screen 14′ approximately some 5″-7″ higher, the user's head CG attitude becomes naturally readjusted upward to a more normal essentially balanced fore/aft attitude 12″, —thereby therapeutically ameliorating the former musculature-stress in the aft-region 10″, —and whereby an approximate horizontal corrected eye/line-of-vision 11″ is thereby attained.

In FIG. 2 is depicted my present basic universal ProviewStand™ comprised of overall framework 15 resting upon horizontal desk surface 13, while supporting a conventional laptop-PC(personal-computer) 14 at an elevated attitude; —this pitch-angle thus necessitating a forward abutment provision such as is facilitated by abutment-pins 30′ which are removable from abutment-pin friction-holes 30 and stowable in friction-fiting stow-holes 24′. This two-piece framework assembly can be made of molded-plastic, extruded-aluminum; or, according to my initial production-model, fabricated from corner-dovetailed and permanently glued-together hardwood as exemplified here. The assembly essentially involves two main structural components cooperating together via one or more frontal hinges 16′ arranged along a single transverese hinge-axis 16. The lower component is rigid base-section 17 having transverse front-rail 17′ and rear-rail 17″ permanently joined together by left/side-rail 17L and right/side-rail 17R, thereby forming a lower/perimeter-subframe which may also include one or more transverse reinforcement-beams 20′ for greater rigidity. The upper component is rigid holder-section 18 having transverse fore-rail 18′ and aft-rail 18″ permanently joined together by left/side-rail 18L and right/side-rail 18R, thereby forming an upper/perimeter-subframe which in plan-view is dimensionally preferably identical to the afore said base-section 17. The box-like framework 15 of FIG. 2 preferably includes reinforcement-beams 20′ and 20″, while the generic-variant embodiment of FIG. 3 would only use reinforcement-beam 20″; —while in any case it is preferred the folding upper holder-section be retained fast in closed-position via simple expedient of interfacing avulsable (hook & loop Velcro®) closure pads 26′ and 26″ which are permanently attached and impinge as is indicated via the attendant action/ref.-arrow 26.

There remain subtle, however vital other differences in the coacting said base-section 17 and holder-section 18 which are to become herein more evident and understood as vitally important provisions. For example, FIG. 2 also shows how the so-called type-A adjuster-rod 21 is manually inserted into one of the U-shaped adjustment-detents 25′ factory formed into the base-section 17 left 17L and right 17R side-rails, —which here exemplified adj.-detents 25′ thus provide the four incremental progressions of pitch-adjustment (see attendant FIG. 2 ref.-X) in support of the upper holder-section 18. By way of example, in FIG. 2, a conventional laptop-PC 14 is indicated resting thereupon in a normal operational position which pitch-angle can be incrementally adjusted to the operator's liking. Study of FIG. 3 shows an essentially equivalent albeit more rudimentary ProviewStand™, functioning substantially the same as the FIG. 2 version, excepting the FIG. 3 embodiment is adapted with a single mono-rail 19 whereto the U-shaped adj.-detents 25.″ are formed transversely entirely through the rail, whereas in the dual-railed embodiment the U-shaped adj.-detents 25″ intrude only about half the rail thickness.

Reference to FIGS. 4A/4B reveals in greater clarity of detail how the type-A adjuster-rod principle works, wherein FIG. 4A shows the adj.-rod 25″ lodged into the adj.-detent nearest hinge-axis 16 so as to thereby set the upper holder-section 18 at a resulting exemplified pitch-angle of 30-degrees or more (dependent actually upon the closeness at which the nearest adj.-detent 25″ is factory made relative to the hinge-axis 16).

If further increased pitch-attitude is desired (for either FIG. 2 or FIG. 3 embodiments), then as shown in FIG. 4B the user merely inserts a couple of spacer-pins 23P (ordinary wooded dowel-pegs are employed in my initial production version) into the factory-made receiver-holes 23H, the auxiliary-rod 23′ thereby being rigidly attached to the basic adj-rod 21 which sub-assembled piggy-backed arrangement can thus be lodged in place between the lower base-section 17 and gravity impinging upper holder-section 18 as is also shown if FIG. 4A. If still greater pitch-attitude is desired, —such as is exemplified in FIG. 3 for reading of a cookbook 28″ (or sheet-music), then slightly longer spacer-pins will serve to position the auxiliary-rod 23′ nearer hinge-axis 16; hence, impinging upon underside of the holder-section 17 as to thereby raise it to a steeper-pitch-angle beyond the 50-degrees indicated.

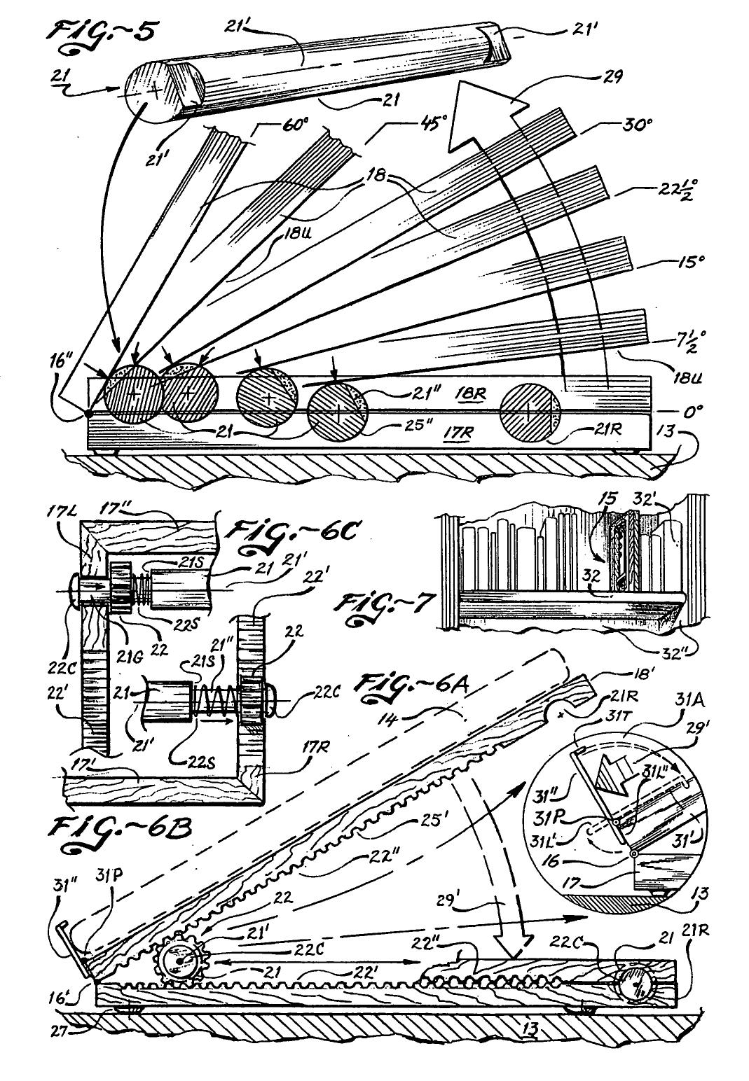

Reference to FIG. 5 teaches an alternate mainframe made according to that set forth in FIGS. 2/3 excepting that the active U-shaped incremental indexing detents are here formed substantially more shallow down into the left and right base-section side-rails; —while the inactive adj.-rod stow-recesses 21R necessarily remain full half-round in formation, with their requisite opposing-half stow-recesses 21R being formed into the lower-side of the holder-section's left and right spar-rails as well. Note also that the black-dot indicated tranverse hinge-axis 16 representation in this more advanced design embodiment, may be simply a thin-web “living hinge” or flexural-hinge 16″, preferably integrally-molded as a resiliently flexile joining-web spanning between the thus simultaneously injection-molded lower base-section 17 and upper holder-section 18. The adj.-rod 21 with its type-B flat-sectors 21′ located at opposite terminuses is shown pictured just above the multi-phased framework 15, the flat-sectors are made oriented on exactly the same radial-plane so that both flats impinge intimately against the underside of the holder-section's spar-rails 18R, —opposite spar-rail 18L not being visible here, but is shown in FIG. 2 (note: —the FIG. 2 mono-rail version of this embodiment obviates need of paired spar-rails). Accordingly, study of the framework 15 in FIG. 5 shows in composite comparison how type-B adj.-rod, when not being used, is stowed at far right captively within the opposed upper and lower stow-recesses, when the ProviewStand™ is folded to its 0-degree condition indicated at the extreme right thereto. When the ProviewStand™ is brought from its convenient optional shelf-top vertically stored location depicted in FIG. 7, the framework is placed upon selected horizontal working-surface 13, whereupon the framework is opened and the stowed adj.-rod 21 is retrieved from its stowed position as to thereby be placed into the selected U-shaped adjustment-detent 25″ corresponding to the overhanging holder-section pitch-attitude desired. Here again at the far right are shown degree-settings at the various pitch-attitude options available in this example; —plus one should also note the six small arrows included within the sight of the spar-rail 18R, which serve to demarcate the adj.-rod's 21 various exemplified impingement points. Thus let us by way of example select the steepest pitch-angle represented here, which is attained via the adj.-detent 25″ shown at the far left of the ProviewStand™ framework, —whereby a 60-degree pitch-angle is thereby provided when the rounded portion of the type-B adj.-rod 21 is rotated so as to impinge against the underside of spar-rail 18R. However, if that pitch-angle is found to be to steep for one's liking, then the type-B adj.-rod is simply rotated upon its axis 21′ until the flat-sector 21′ instead becomes redirected toward the spar-rail 18R, —thereby reducing the pitch-angle to a lesser 45-degree pitch-angle, which may thus be found to be appropriate to ones particular usage. If some other pitch-angle is deemed to be more desirable, then the same procedure is to be employed relative to another adj.-detent 25″ located further aftward from the frontal hinge-axis 16″. In any case, one can see in FIG. 5 how the user may axially-rotate the adj.-rod 21 whereby either the flat-sector (delineated via cross-hatching in contrast to stippled region) or the otherwise rounded-surface of the adj.-rod 21 is used to their advantage.

In final FIGS. 6A/6B/6C is set forth a type-C adjustment-rod 21 which instead of a flat-sector is adapted with opposed terminus gudgeons (reduced diameter axle like portion) 21G upon which is slip-fitted an opposed pair of freely rotating cog-wheels 22, both secured outwardly via a snap-on or glued-on hubcap 22H. Note that this framework 15 embodiment is preferably configured structurally according to that example of FIG. 2, however the laterally arranged detents are formed much smaller so as to thereby serve as a pair of opposed gear racks or cog-racks formed 22′ into the upper-surface of side-rails 18L(lower) and 22″ into the interfacing under-surface of spar-rails 18R(upper); —thus each pair of cog-racks thereby functioning in precise meshing engagement with an interstitially juxtaposed cog-wheel 22. Since the engaged cog-wheel 22 as exemplified in FIG. 6A cannot rotate once it is cooperatively engaged positively into both the lower 22′ and upper 22″ cog-racks, —the cog-wheels 22 are hence simultaneously locked fast in-place, and cannot be moved until the user manually lifts the overhanging holder-section 18 from gravity weighted engagement upon the left and right cog-wheels 22 (also see FIG. 6B), —whereby the user can readily shift the adj.-rod 21 and its sympathically rolling cog-wheels 22 to an alternate forward or aftward position as desired to select their preferred pitch-attitude; whereupon the user then merely re-lowers the holder-section 18 upon cog-racks 22″ which thus effectively re-locks the cog-wheels 22 into the opposed cog-racks. The cog-racks 22′/22″ can be inexpensively incorporated into injection-molding die-tooling so as to be integrally-molded into the side and spar rails 17R/18R, and the cog-wheels 22 can even be inexpensively sliced from extruded lengths. So as to enable the factory assembled adj.-rod 21 to be conveniently carried with the compactly-folded framework 15, we have again resorted to providing the opposed pairs of U-shaped stow-recesses 21R, which are here formed entirely through the aftward regions of the side-rails 17L and 17R and the corresponding inverted U-shaped stow-recesses 21R formed into the overhanging spar-rails 18R. Referring to FIG. 6C reveals how the cog-wheels 22 can each be manually biased inwardly against attendant shift return-spring 22S which abuts inward-stop 21S, thereby enabling the adj.-rod 21 to drop into captive stow position made final by downward closing of the holder-section 18; —while subsequent reuse merely involves opening of the framework and lifting of the adj.-rod 21 from the lower stow-recesses 21R, so as to again deploy the adj.-rod to the desired pitch-attitude position as has been explained above.

Another optional feature revealed in FIG. 6A is the conveniently retractable abutment-flap 31, which obviates need of the detachable abutment-pins 30 (see FIGS. 2/3), and preferably extends approximately the full-width of the fore-rail 18′ (see FIGS. 2/3 for better view of fore-rail) so as to be effective for use with an open-book as well (note a pair of left and right spaced apart right-angle page/stay-tabs 31T become directed down between the spar-rails when abutment-flap is retracted). Thus as shown in the circular inset/detail-view thereto, when the ProviewStand™ 15 is stored-away (such as exemplified in FIG. 7), or carried within a labtop-PC's conventional carry-case (not shown), the abutment-flap 31 is simply retractably folded-down to position 31′ (see action ref.-arrow 31A) leaving the dependent leg 31L′ portion free; 13 but then when the ProviewStand™ is once again being set-up for use (in a school-room or sales-meeting for example), —as the abutment-flap is raised to an approximant right-angle upwardly extended active-position, its opposite integrally formed leg 31′ portion thus becomes simultaneously swung down to positively impinge to a stop against the front-surface of the fore-rail 18′. Since the abutment-flap 31′ and its integral leg 31L′ are coperative upon a common transverse pivot-axis 31P moored upon the fore-rail 18′, the aggregate subassembly is ultimately simple and effective. The ProviewStans™ is now ready to receive the laptop-PC 14, —which is thus allowed to gently slide-down 31S (see gravity action/ref.-arrow 29′) and thereby securely abut to a stop at its operational position, just as it did in FIG. 2 relative to the abutment-pins 30.

Thus, it is readily understood how the preferred and generic-variant embodiments of this invention contemplate performing functions in a novel way not heretofore available nor realized. It is implicit that the utility of the foregoing adaptations of this invention are not necessarily dependent upon any prevailing invention patent; and, while the present invention has been well described hereinbefore by way of certain illustrated embodiments, it is to be expected that various changes, alterations, rearrangements, and obvious modifications may be resorted to by those skilled in the art to which it relates, without substantially departing from the implied spirit and scope of the instant invention. Therefore, the invention has been disclosed herein by way of example, and not as imposed limitation, while the appended Claims set out the scope of the invention sought, and are to be construed as broadly as the terminology therein employed permits, reckoning that the invention verily comprehends every use of which it is susceptible. Accordingly, the embodiments of the invention in which an exclusive property or proprietary privilege is claimed, are defined as follows.

What is claimed of proprietary inventive origin is:

1. A hand-portable multi-purpose utility-stand; said apparatus comprising:
a rigid framework assembly with frontal transverse hinge-axis means serving the co-hinging function of joining an upper overhanging holder-section means to a cooperative lower base-section means having longitudinal incrementally spaced apart detent means for selective indexing of a separate transverse adjuster-rod means thus impinging upwardly against underside of said holder-section longitudinal side-rail means, whereby manually repositioning said adjuster-rod into said detents located closer to said hinge-axis thus raises the pitch-attitude of said holder-section; said holder-section including a forward slide-abutment means.

2. The utility-stand apparatus according to claim 1, wherein upon removal of said adjuster-rod from deployment into said detent means and subsequent inserting of said adjuster-rod's terminuses into transversely paired interfacing stow-mode stow-recess means located at aftward region of said base-section and holder-section members, said framework assembly is thereby able to close flatly together with said adjuster-rod held captively therein; whereupon the framework assembly is so maintained via closure means for compact folded-carrying, or for spatially efficient up-ended storing upon a shelf in the manner of a book.

3. The utility-stand apparatus according to claim 2, wherein said closure means is provided by impinging albeit avulsable conventional hook-and-loop fasteners respectively aligned permanently affixed upon the opposed upper and lower interfacing surfaces of said framework's transverse aft and rear rail members.

4. The utility-stand apparatus according to claim 1, wherein said holder-section includes an abutment means, serving to prevent a supported article from sliding down forwardly therefrom regardless as to user's selected pitch-angle adjustment.

5. The holder-section according to claim 4, wherein said slide-abutment means is a pair of spaced apart abutment-pins which are manually inserted into pin-holes made into the upper-surface of the transverse fore-rail as well as the upper-surface of said longitudinal upper/side-rails; said abutment-pins being removable and conveniently stowed into friction fitting stow-holes provided in the forward-facing surface of the aft-rail.

6. The utility-stand apparatus according to claim 1, wherein said slide-abutment means is a transversely arranged rigid planar abutment-flap acting upon a transverse pivot-axis dependent from said fore-rail, and including an integrally formed opposing leg portion, whereby said abutment-flap may either be manually retracted during disuse to a low-profile position down parallel to upper-surface of said fore-rail, or alternately said abutment-flap can be pivotally raised to a right-angle whilst said leg portion serves as a stop impinged down against front surface of said fore-rail; thereby affording a solid abutment as a rest for an article supported upon said holder-section.

7. The utility-stand apparatus according to claim 1, wherein said incrementally spaced apart U-shaped detents are each made to equally relieved depths forming approximate half-circular seats; whereby an optional auxiliary-rod means can be introduced juxtaposed between said adjuster-rod and underside of said holding-section.

8. The utility-stand apparatus according to claim 7, wherein both said adjuster-rod and said auxiliary-rod include a pair of spaced apart holes made at a right-angle to a depth approximately bisecting their respective axes, each aligning pair of receiver-holes thus accepting the opposite ends of a spacer-pin acting to physically join them closely together as to thereby provide increased pitch-angle adjustability.

9. The utility-stand apparatus according to claim 1, wherein said incrementally spaced apart detents are formed to unequally relieved arc-depths sized to diametrically mate with said adjuster-rod which opposed terminuses also include a aligned flat-sector, thereby enabling said adjuster-rod to be manually rotated as to selectively impinge either its rounded portion or its flatted portion up against said holder-section as a means of attaining an interim pitch-angle.

10. The utility-stand apparatus according to claim 1, wherein said incrementally spaced apart detents are also identically formed Into said holder-section's right and left longitudial spar-rails at equal intervals and equally relieved depths, thus tantamount to an opposed pair of upper and lower cog-racks.

11. The opposed gear-rack arrangement according to claim 10, wherein the adjuster-rod's said terminuses include a cog-wheel means capable of simultaneously engaging both respective said upper and lower regular said detents, thereby resulting in a locked condition of said regular detent engaging cog-wheels, which positively holds one of various selected positions when said adjuster-rod is deployed to an alternate fore or aft position, said holder-section being momentarily lifted from engagement with said adjuster-rod terminus cog-wheels to effect repositioning of said adjuster-rod.

12. The opposed gear-rack arrangement according to claim 11, wherein said cog-wheels are slidably mounted upon said adjuster-rod, said cog-wheels being normally slidingly biased fully outward against opposite terminus hubcaps; and said adjuster-rod may be conveniently lifted from its active-position, whereupon user manually slides said cog-wheels inboard of said right and left frame-rails whereby said adjuster-red-terminuses can thus be held captive within stow-mode stow-recess means.

13. The utility-stand apparatus according to claim 1, wherein said base-section is planar, formed with four contiguous right-angle corners, whereto longitudinal side-rails are permanently joined into a transverse front-rail and a transverse rear-rail.

14. The utility-stand apparatus according to claim 1, wherein said holder-section is planar, formed with four contiguous right-angle corners, whereto longitudinal spar-rails are permanently joined into a transverse fore-rail and a transverse aft-rail.

15. A hand-portable desk-top multi-purpose utility-stand, suitable for usage with an existing laptop-PC or reference-book for example; said apparatus comprising:
a framework assembly having a base-section means with right and left longitudinal side-rails having incrementally spaced-apart plural detent means, said base-section being permanently joined via a co-hinging frontal transverse hinge-axis means to an upper holder-section means, whereby user selectively obtains desired pitch-angle adjustment through insertion of a separate transverse adjuster-rod means into said detents, whereby a steeper adjustment is thereby attained as said adjuster-rod is selectively repositioned into detents located progressively closer relative to said hinge-axis; whereto an existing article to may thus be rested atop upper-surface of said holder-section, hence enabling a more suitably elevated viewing height than would otherwise be provided by a normal desktop surface alone.

16. The utility-stand apparatus according to claim 15, wherein upon removal of said adjuster-rod from deployment into said detents and subsequent inserting of said adjuster-rod's terminuses into transversely paired interfacing U-shaped stow-mode stow-recesses located at aftward-end of respective said base-section and holder-section, said framework assembly is thereby able to close flatly together with said adjuster-rod held captively therein; whereupon the framework-assembly is so maintained via closure means for compact folded-carrying, or for spatially efficient storing upon an existing book-shelf.

17. The utility-stand apparatus according to claim 15, wherein said incrementally spaced-apart detents are also identically formed into said holder-section's right and left longitudial spar-rails at equal regular intervals and depths, said adjuster-rod's opposed terminuses including a cog-wheel means capable of simultaneously engaging both respective said upper and lower regular said detents, thereby providing a locked condition of said regular detent engaging cog-wheels thus positively holding any selected pitch-angle; plus, said cog-wheels are slidably mounted and freely-rotate upon said adjuster-rod's opposed gudgeons whereto coaxial compression-springs are staged as to impinge between diametrically larger inward-stops and inward-face of said cog-wheel, thereby normally biasing opposed said cog-wheels outward against a terminus hubcap; yet when said adjuster-rod is removed from its active-position, the user merely slides the cog-wheels inboard of said right and left frame-rails so as to be thus become received captively into stow mode of stow-recess means.

18. The utility-stand apparatus according to claim 15, wherein said holder-section includes slide-abutment means preventing a supported article from sliding down forwardly therefrom regardless as to user's selected pitch-angle adjustment, said slide-abutment means comprising a pair of spaced apart abutment-pins manually inserted into pin-holes made into the upper-surface of the transverse fore-rail; said abutment-pins being readily removable and for stowing into friction-fit stow-holes provided in the forward-facing surface of said aft-rail.

19. The utility-stand apparatus according to claim 15, wherein said incrementally spaced apart detents are formed to unequally relieved arc-depths sized to diametrically mate with said adjuster-rod which opposed terminuses also include a aligned flat-sector, thereby enabling said adjuster-rod to be manually rotated as to selectively impinge either its rounded portion or its flatted portion up against said holder-section as a means of attaining an interim pitch-angle.

20. A method of supporting a conventional Laptop-PC at an enhanced Human-engineered attitude for improved desk-top viewing, said method comprising:
providing a framework assembly having a frontal transverse hinge-axis joining a base-section means to a thereby adjustable-pitch holder-section means;
manually deploying a separate adjuster-rod transversely into user selected indexing detents arranged at spaced apart intervals along the right and left longitudinal side-rails and spar-rails of said framework assembly, thereby achieving a generally desired 20-degree to 60-degree pitch-angle;
placing one's laptop-PC atop said holder-section whereby the laptop-PC slides down against a frontal abutment means, thereby placing back portion of the laptop-PC is poised higher than the front, opening the laptop-PC's display-screen lid to an approximate vertical attitude now advantageously about 5-inches or more above its normal unassisted desktop position;
resultant repositioning of the display-screen thereby ergonomically obviating a tiring forward head-tilt found to induce significant neck-musculature strain and associated operator fatigue.
